(19) United States
(12) Patent Application Publication
(10) Pub. No.: US 2009/0130506 A1
(43) Pub. Date: May 21, 2009

(54) Apparatus for generating hydrogen and fuel cell power generation system having the same

(75) Inventors: Jae-Hyuk Jang, Seongnam-si (KR); Kyoung-Soo Chae, Suwon-si (KR); Jae-Hyoung Gil, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electro-Mechanics Co., Ltd., Suwon (KR)

(21) Appl. No.: 12/292,397

(22) Filed: Nov. 18, 2008

(30) Foreign Application Priority Data
Nov. 20, 2007 (KR) 10-2007-0118830

(51) Int. Cl. H01M 8/18

(52) U.S. Cl. 429/19; 204/230.8

(57) ABSTRACT

An apparatus for generating hydrogen and a fuel cell power generation system equipped with the apparatus are disclosed. The apparatus can include an electrolyte bath containing the electrolyte solution, an anode positioned inside the electrolyte bath and configured to generate electrons, a cathode positioned inside the electrolyte bath and configured to receive the electrons from the anode to generate hydrogen, and a supplementary device configured to increase an amount of the hydrogen generated. The apparatus can be utilized to increase the amount of hydrogen generation at initial operation and reduce the time required to reach steady state.

### CROSS-REFERENCE TO RELATED APPLICATIONS

This application claims the benefit of Korean Patent Application No. 10-2007-0118830 filed with the Korean Intellectual Property Office on Nov. 20, 2007, the disclosure of which is incorporated herein by reference in its entirety.

### BACKGROUND

1. Technical Field

The present invention relates to an apparatus for generating hydrogen and a fuel cell power generation system equipped with the apparatus.

2. Description of the Related Art

A fuel cell is an apparatus that converts the chemical energies of fuel (hydrogen, LNG, LPG, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes. As such, the fuel cell is a relatively new technology for generating-power, which offers high efficiency and few environmental problems.

Examples of fuel cells being researched for application to portable electronic devices include the polymer electrolyte membrane fuel cell (PEMFC), which uses hydrogen as fuel, and the direct liquid fuel cell, such as the direct methanol fuel cell (DMFC), which uses liquid fuel directly. The PEMFC provides a high output density, but requires a separate apparatus for supplying hydrogen. Using a hydrogen storage tank, etc., for supplying the hydrogen can result in a large volume and can require special care in handling and keeping.

Methods used in generating hydrogen for a polymer electrolyte membrane fuel cell (PEMFC) can be divided mainly into methods utilizing the oxidation of aluminum, methods utilizing the hydrolysis of metal borohydrides, and methods utilizing reactions on metal electrodes. Among these, one method of efficiently regulating the rate of hydrogen generation is the method of using metal electrodes. This is a method in which the electrons obtained when magnesium in the electrode is ionized to Mg²⁺ ions are moved through a wire and connected to another metal object, where hydrogen is generated by the dissociation of water. The amount of hydrogen generated can be regulated, as it is related to the distance between electrodes and the sizes of the electrodes.

However, conventional methods for generating hydrogen may entail a prolonged duration of time until steady state is reached, at initial operation for hydrogen generation. As such, there is a need for an apparatus for generating hydrogen and a fuel cell power generation system that have improved initial response properties.

### SUMMARY

An aspect of the invention is to provide an apparatus for generating hydrogen and a fuel cell power generation system equipped with the apparatus, which reduces the time required to reach steady state at initial operation for hydrogen generation.

One aspect of the invention provides an apparatus for generating hydrogen by dissociating an electrolyte solution. The apparatus can include an electrolyte bath containing the electrolyte solution, an anode positioned inside the electrolyte bath and configured to generate electrons, a cathode positioned inside the electrolyte bath and configured to receive the electrons from the anode to generate hydrogen, and a supplementary device configured to increase an amount of the hydrogen generated.

Another aspect of the invention provides a fuel cell power generation system for producing electrical energy using hydrogen generated by dissociating an electrolyte solution. The fuel cell power generation system can include an electrolyte bath containing the electrolyte solution, an anode positioned inside the electrolyte bath and configured to generate electrons, a cathode positioned inside the electrolyte bath and configured to receive the electrons from the anode to generate hydrogen, a supplementary device configured to increase an amount of the hydrogen generated, and a fuel cell configured to convert chemical energy of the hydrogen generated at the cathode to produce the electrical energy.

Certain embodiments of the invention may include one or more of the following features. The supplementary device can include a supplementary cell configured to supply additional electrons to the cathode.

The supplementary cell can be electrically connected between the anode and the cathode, and can be operated by a flow of electricity between the anode and the cathode.

The supplementary cell can be a secondary cell that is charged, during the process of generating hydrogen, by surplus electrons from the anode.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic diagram of an apparatus for generating hydrogen according to an embodiment of the invention.

FIG. 2 is a schematic diagram of a fuel cell power generation system according to another embodiment of the invention.

### DETAILED DESCRIPTION

The hydrogen generating apparatus and fuel cell power generation system according to certain embodiments of the invention will be described below in more detail with reference to the accompanying drawings. Those components that are the same or are in correspondence are rendered the same reference numeral regardless of the figure number, and redundant explanations are omitted.

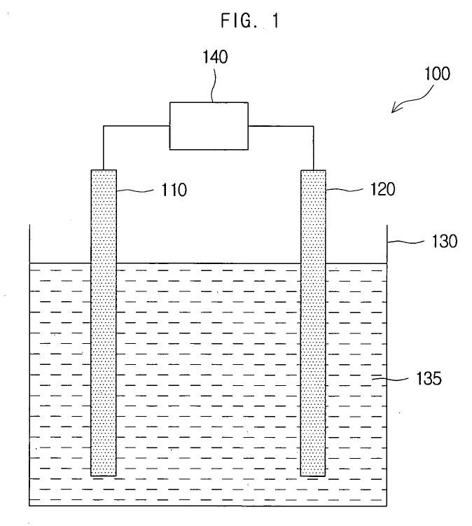

FIG. 1 is a schematic diagram of an apparatus for generating hydrogen according to an embodiment of the invention. In FIG. 1, there are illustrated a hydrogen generating apparatus 100, an anode 110, a cathode 120, an electrolyte bath 130, an electrolyte solution 135, and a supplementary cell 140.

The following descriptions will refer to a supplementary cell 140, which supplies additional electrons to the cathode 120, as an example of a supplementary device.

In this particular embodiment, a hydrogen generating apparatus 100 is presented, in which a supplementary cell 140 may be electrically connected between the anode 110 and cathode 120, to increase the amount of hydrogen generation at initial operation and reduce the time required to reach steady state. A secondary cell can be used, so that the cell may be charged by receiving surplus electrons from the anode 110 during operation.

Here, the time required to reach steady state refers to the duration of time from the point at which electricity flows through the anode 110 and cathode 120 in the hydrogen generating apparatus 100 to generate hydrogen until the point at which the amount of hydrogen generation reaches a desired value. The phrase will be intended to convey the same meaning hereinafter.

The electrolyte bath 130 may contain an electrolyte solution 135 that produces hydrogen by way of dissociation. The anode 110 and the cathode 120 may be positioned inside the electrolyte bath 130, so that a reaction for generating hydrogen may be performed using the electrolyte solution 135 contained in the electrolyte bath 130.

A compound such as LiCl, KCl, NaCl, KNO₃, NaNO₃, CaCl₂, MgCl₂, K₂SO₄, Na₂SO₄, MgSO₄, AgCl, etc., can be used in the electrolyte solution 135. The electrolyte solution 135 can also include hydrogen ions.

The anode 110 may be the active electrode, and may be positioned inside the electrolyte bath 130 to generate electrons. The anode 110 can be made of magnesium (Mg), for example, and due to the difference in ionization tendency between the anode 110 and hydrogen, the anode 110 can release electrons into the water and to be oxidized into magnesium ions (Mg²⁺).

The electrons generated thus can travel to the cathode 120. The anode 110 may be expended in accordance with the electrons generated, and may be configured to allow replacement after a certain period of time. Also, the anode 110 can be made of a metal having a greater tendency to ionize than the material used for the cathode 120 described below.

The cathode 120 may be the inactive electrode and hence may not be expended, unlike the anode 110, and thus the cathode 120 may be implemented with a lower thickness than that of the anode 110. The cathode 120 can be positioned inside the electrolyte bath 130, and can receive the electrons generated at the anode 110 to generate hydrogen.

The cathode 120 can be made of stainless steel, for example, and can react with the electrons to generate hydrogen. That is, the chemical reaction at the cathode 120 involves water being dissociated, after receiving the electrons from the anode 110, to form hydrogen at the cathode 120.

The reaction above can be represented by the following Reaction Scheme 1.

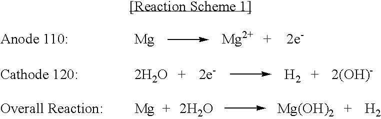

A control unit (not shown) may be electrically connected to the anode 110 and cathode 120 to control the flow of electricity between the anode 110 and cathode 120. The operation of the control unit (not shown) may be inputted with the amount of hydrogen required by the fuel cell, and if the required value is high, may increase the amount of electrons flowing from the anode 110 to the cathode 120, or if the required value is low, may decrease the amount of electrons flowing from the anode 110 to the cathode 120.

For example, the control unit (not shown) may include a variable resistance element, to regulate the amount of electrons flowing between the anode 110 and cathode 120 by varying the resistance value, or may include an on/off switch, to regulate the amount of electrons flowing between the anode 110 and cathode 120 by controlling the on/off timing.

The supplementary cell 140 can supply additional electrons to the cathode 120 to increase the amount of hydrogen generated. That is, if the amount of hydrogen generation is below a required value, the supplementary cell 140 can be electrically connected with the cathode 120 and can supply additional electrons to the cathode 120, so that the amount of hydrogen generated may be increased. The operation of the supplementary cell 140 can be controlled using the control unit (not shown) described above.

Also, the supplementary cell 140 can be electrically connected between the anode 110 and the cathode 120 and can be operated by the flow of electricity between the anode 110 and cathode 120. With the supplementary cell 140 electrically connected by way of the control unit (not shown) between the anode 110 and cathode 120, the control unit (not shown) may enable a flow of electricity between the anode 110 and the cathode 120, by which the supplementary cell 140 can be operated as well.

In other words, each electrode of the supplementary cell 140 can be electrically connected to the anode 110 and cathode 120, respectively, and the control unit (not shown) that controls the flow of electricity between the anode 110 and cathode 120 can be electrically connected to the anode 110 and cathode 120. Therefore, when electricity is applied to the anode 110 and cathode 120 by the control unit (not shown), the supplementary cell 140 can be made to supply electrons to the cathode 120, without having to provide separate control for the supplementary cell 140, so that the supplementary cell 140 may serve as a starter and increase the amount of hydrogen generation during initial operation of the hydrogen generating apparatus 100.

By using the supplementary cell 140 that can be electrically connected between the anode 110 and cathode 120, the amount of hydrogen generated during initial operation can be increased, and therefore the time required to reach steady state can be reduced. As a result, the hydrogen generating apparatus 100 can be implemented that is capable of generating hydrogen more quickly and that has improved initial response properties.

The supplementary cell 140 may be a secondary cell, which can be supplied with surplus electrons from the anode 110, and charged, during the generation of hydrogen. Thus, after the operation of the hydrogen generating apparatus 100 has reached steady state, the electrons generated at the anode 110, other than those that have traveled to the cathode 120 and participated in the reaction, can be supplied to supplementary cell 140 to charge the supplementary cell 140.

As the excess electrons remaining from the reaction may be used to charge the supplementary cell 140, the hydrogen generating apparatus 100 can be implemented that provides higher energy efficiency and does not require replacing the supplementary cell 140.

While this particular embodiment has been described using a supplementary cell 140 as an example of a supplementary device, it will be appreciated that the invention encompasses various other compositions and arrangements, known to those skilled in the art, which can increase the amount of hydrogen generation at the cathode 120.

Next, an example will be described for a fuel cell power generation system according to another embodiment of the present invention.

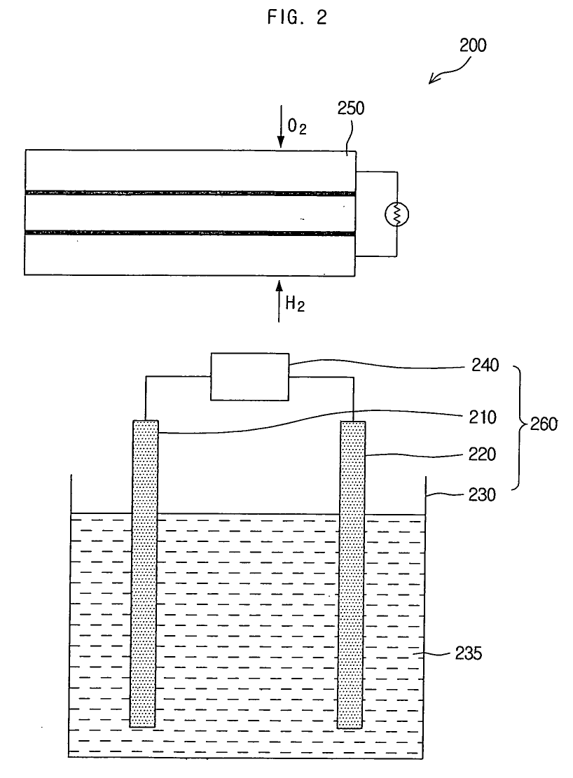

FIG. 2 is a schematic diagram of a fuel cell power generation system according to another embodiment of the invention. In FIG. 2, there are illustrated a fuel cell power generation system 200, a fuel cell 250, a hydrogen generating apparatus 260, an anode 210, a cathode 220, an electrolyte bath 230, an electrolyte solution 235, and a supplementary cell 240.

In this particular embodiment, a fuel cell power generation system 200 is presented, in which a supplementary cell 240 may be electrically connected between the anode 210 and cathode 220, to increase the amount of hydrogen generation at initial operation and reduce the time required to reach steady state. A secondary cell can be used, so that the cell may be charged by receiving surplus electrons from the anode 210 during operation. As such, the fuel cell power generation system 200 can be utilized to provide a more stable supply of electrical energy.

In this embodiment, the compositions of the hydrogen generating apparatus 260, anode 210, cathode 220, electrolyte bath 230, electrolyte solution 235, and supplementary cell 240 are substantially the same as or in correspondence with those of the embodiment described above for a hydrogen generating apparatus 100, and thus will not be described again. The descriptions that follow will focus on the fuel cell 250, which forms the main difference from the previously described embodiment.

The fuel cell 250 can convert the chemical energy of hydrogen generated at the cathode 220, to produce electrical energy. That is, the pure hydrogen generated by the hydrogen generating apparatus 260 equipped with the supplementary cell 240 can be moved to the fuel electrode of the fuel cell 250, where the chemical energy of the hydrogen generated at the hydrogen generating apparatus 260 described above may be converted into electrical energy to produce a direct current.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. Many embodiments other than those set forth above can be found in the appended claims.

What is claimed is:

1. An apparatus for generating hydrogen by dissociating an electrolyte solution, the apparatus comprising:
an electrolyte bath containing the electrolyte solution;
an anode positioned inside the electrolyte bath and configured to generate electrons;
a cathode positioned inside the electrolyte bath and configured to receive the electrons from the anode to generate hydrogen; and
a supplementary device configured to increase an amount of the hydrogen generated.

2. The apparatus of claim 1, wherein the supplementary device comprises a supplementary cell configured to supply additional electrons to the cathode.

3. The apparatus of claim 2, wherein the supplementary cell is electrically connected between the anode and the cathode and is operated by a flow of electricity between the anode and the cathode.

4. The apparatus of claim 2, wherein the supplementary cell is a secondary cell charged by surplus electrons from the anode during the hydrogen generation.

5. A fuel cell power generation system for producing electrical energy using hydrogen generated by dissociating an electrolyte solution, the fuel cell power generation system comprising:
an electrolyte bath containing the electrolyte solution;
an anode positioned inside the electrolyte bath and configured to generate electrons;
a cathode positioned inside the electrolyte bath and configured to receive the electrons from the anode to generate hydrogen;
a supplementary device configured to increase an amount of the hydrogen generated; and
a fuel cell configured to convert chemical energy of the hydrogen generated at the cathode to produce the electrical energy.

6. The fuel cell power generation system of claim 5, wherein the supplementary device comprises a supplementary cell configured to supply additional electrons to the cathode.

7. The fuel cell power generation system of claim 6, wherein the supplementary cell is electrically connected between the anode and the cathode and is operated by a flow of electricity between the anode and the cathode.

8. The fuel cell power generation system of claim 6, wherein the supplementary cell is a secondary cell charged by surplus electrons from the anode during the hydrogen generation.
